(19) United States
(12) Patent Application Publication
(10) Pub. No.: US 2009/0132224 A1
(43) Pub. Date: May 21, 2009

(54) Co-Simulation System Using a Slow Operation Mode that Allows Detailed Interaction with Hardware and a Fast Operation Mode

(76) Inventors: Stefan Reichor, Wartberg/Aist (AT); Dieter Scheurer, Waiblingen (DE)

Correspondence Address: HENRY M FEIEREISEN, LLC;HENRY M FEIEREISEN, 708 THIRD AVENUE, SUITE 1501, NEW YORK, NY, 10017, US

(21) Appl. No.: 12/065,182

(22) PCT Filed: Sep. 1, 2005
(86) PCT No.: PCT/DE2005/001537

§ 371 Date: Feb. 28, 2008

(51) Int. Cl. G06F 9/44

(52) U.S. Cl. 703/21

(57) ABSTRACT

The invention relates to a hardware/software co-simulation system comprising a simulator and a hardware block coupled thereto with an I/O manager and at least one DUT (“Device under Test”), the co-simulation system comprising a first operating mode (Mode 1), wherein the I/O manager can forward a request from the simulator to the DUT on each clock cycle and a method for hardware/software co-simulation of a simulator with a synchronous electronic system. The aim of the invention is to improve the above such that the simulation times are significantly reduced. Said aim is achieved, whereby the co-simulation system comprises a second operating mode (Mode 2), wherein the I/O manager only forwards the clock signal (DUTC1k) to the DUT without forwarding further requests to the DUT and a seamless switching between both operating modes (Mode 1, Mode 2) is possible during a simulation.

The invention refers to a hardware/software co-simulation system comprising a simulator and a coupled hardware block which contains an I/O-manager and at least one DUT (“Device under Test”), whereas the co-simulation system has a first operation mode, at which the I/O-manager can forward a request from the simulator to that DUT at every clock cycle, and to a method for a hardware/software co-simulation of a simulator with a clocked electronic system at which the simulator is coupled with a hardware block having an I/O-manager and at least one DUT (“device under test”) whereas in a first operation mode the I/O-manager is able to forward a request from the simulator to the DUT at every clock cycle.

Nowadays electronic developments grow increasingly complex because more powerful functionality and simulations is required, but the development timeframe stays the same or is even decreased. To guarantee the correct functionality of such a complex system, larger numbers of simulation runs are needed. To simulate the whole system it is necessary to run a co-simulation or to build a prototype.

Known hardware/software co-simulation systems that allow the co-simulation of a simulator with a clocked electronic system comprise a simulator and a coupled hardware block which contains an I/O-manager and at least one DUT (“device under test”). the DUT shall be integrated in a running simulation of the simulator. A part of the simulator and the I/O-manager are responsible for the integration of the DUT as a simulation model in the simulation. State of the art systems use an I/O-manager that forwards one request from the simulator to the DUT at every clock cycle. This is called a tight coupling, because of the data transfer between the simulator and the coupled DUT that occurs at every clock cycle. The drawback of the state of the art methodology is, that the simulation run times are often very long depending on the kind of simulation.

In contrast it is the object of the invention, to present a hardware/software co-simulation system and a method for a hardware/software co-simulation to decrease the simulation run times significantly.

The problem is solved by using the features of the independent claims. the hardware/software co-simulation system is comprising a simulator and a coupled hardware block having an I/O-manager and at least one DUT (“device under test”). The co-simulation system has a first operation mode at which the I/O-manager can forward a request from the simulator to the DUT in every clock cycle. Furthermore according to the invention there is a second operation mode of the co-simulation system allowing the I/O-manager to only send the clock (DUTClk) to the DUT, without sending further requests to the DUT, and a seamless switching between these two operation modes is possible during a simulation. The invention allows the acceleration of hardware/software co-simulations, by running simulations without the usually necessary tight coupling between the software and the coupled hardware in this problem area. The tight coupling means that at every clock cycle sent to the coupled system it is also possible to exchange additional data about the state of the coupled system. The invention allows a seamless switching between the tight coupling and a loose coupling at which no data is transferred between the simulated software and the coupled hardware block. Only the clock signal is sent to the hardware to allow an accelerated simulation of the hardware. There is no limitation concerning the number of possible switches from the tight to the loose coupling during a running hardware/software co-simulation.

The dependent claims concern advantageous embodiments of the invention.

The simulator is favorably a computer program running on a computer. The computer system and the kind of computer program can be selected to be useful in practical use.

The I/O-manager and the DUT can be located on the same or on different hardware devices.

The invention can be used for the co-simulation of a simulator with a clocked electronic system, whereas the DUT is integrated in a running simulation of the simulator. a part of the simulator and the I/O-manager are responsible for the integration of the DUT in the simulation.

The concept of the invention can be subdivided in two modes of operation. in a first operation mode (co-simulation), corresponding to a conventional co-simulation, the I/O-manager can forward one request from the simulator to the DUT on every clock cycle leading to a tight coupling between the simulator and the coupled DUT. In a second operation mode (clock acceleration) the simulation is running faster, because the I/O-manager sends only the clock (DUTClk) to the DUT. No further requests are forwarded to the DUT in this operation mode. This operation mode implements a loose coupling, because no other interaction happens between the simulator (software part) and the coupled hardware when the clock is offered at DUTClk.

According to a development, in the second operation mode a message from the simulator to the I/O-manager is possible concerning the number of clock cycles that should be executed in the fast operation mode (NumOfClks) and/or concerning a breakpoint condition that depends on the current state of the DUT.

A further development of this embodiment will use an I/O-manager with a breakpoint logic which examines the appearance of the breakpoint condition in the second operation mode.

A real acceleration of the co-simulation is particularly reached, when the generated DUTClk from the I/O-manager in the second operation mode is higher than the used clock in the first operation mode, i.e. it is also higher than the clock frequency of the simulator (SimClk).

The invention is further explained in the drawings. It is shown in:

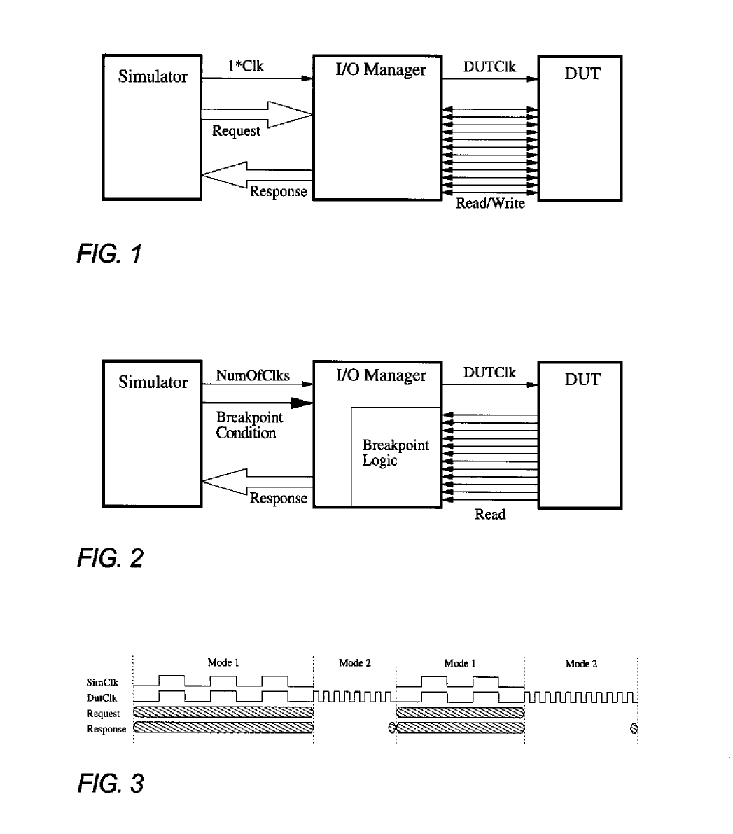

FIG. 1 a structure for the first operation mode (co-simulation),

FIG. 2 a structure for the second operation mode (clock acceleration),

FIG. 3 a timing diagram, showing both operation modes.

FIG. 1 shows the first operation mode 1 (co-simulation). in this operating mode it is possible to send a request in every clock cycle. this request is forward from the I/O-manager to the DUT. In the next step a clock edge is emitted on DUTClk. After each clock cycle a response is calculated by the I/O-manager and sent back to the simulator. A bidirectional data transfer read/write is possible between the I/O-manager and the DUT. the simulator can decide after each clock cycle, if the simulation should continue in mode 1 or in mode 2.

FIG. 2 shows the second operation mode 2. In this operation mode, the simulator sends the number of clocks (NumOfClks) to be executed fast. Additionally it is possible to define a breakpoint condition that depends on the current state of the DUT.

As soon as the I/O-manager has received the number of clock cycles and the optional breakpoint condition, it starts to emit clock edges on DUTClk. These clock edges in mode 2 use a higher clock frequency than in mode 1 (hence the name “clock acceleration” for mode two). Emitting clock edges on DUTClk is topped, as soon as one of the following conditions is met:

the number of clock edges specified by NumOfClks was emitted.
the condition specified by the breakpoint condition is met. This condition is checked by the breakpoint logic of the I/O-manager all the time.

There is only an unidirectional data exchange read between the I/O-manager and the DUT. After stopping the clock output on DUTClk, the I/O-manager sends a response back to the simulator. The simulator can now decide, if the simulation should continue in mode 1 or in mode 2.

FIG. 3 is an exemplary timing diagram showing the simulator clock (SimClk), the clock that is sent from the I/O-manager to the DUT (DUTClk) as well as the request from the simulator to the I/O-manager and the response from the I/O-manager to the simulator.

The figure shows that in mode 1 the clock is generated by the simulator. in addition, data can be sent from the simulator to the DUT (request) and data can be sent from the DUT to the simulator (response) on every clock cycle. However, in mode 2, the simulator only starts the emission of clock edges on DUTClk. There is no interaction between the I/O-manager and the simulator during the emission of the clock edges on DUTClk. Only a response is sent to the simulator after the last clock edge is emitted or the break condition is met.

FIG. 3 further shows that it is possible to switch seamlessly between both operation modes. The figure shows a small part of a simulation during which much more clock edges are generated, of course.

1.-7. (canceled)

8. A simulation system for simulating a device-under test (DUT), comprising:
a simulator operating at a clock frequency,
a hardware block coupled to the simulator and comprising an I/O-Manager and at least one DUT, said I/O-Manager receiving requests from the simulator, said hardware block,
wherein in a first operating mode, the I/O-Manager transmits the requests to the DUT at every clock cycle, and in a second operation mode, the I/O-Manager transmits the clock cycles to the DUT without transmitting the requests, and
wherein the simulator is configured to seamlessly switch between the first and second operating modes.

9. The simulation system of claim 8, wherein the I/O-Manager and the DUT are located on the same device.

10. The simulation system of claim 8, wherein the I/O-Manager and the DUT are located on different devices.

11. The simulation system of claim 8, wherein in the second operation mode, the simulator indicates to the I/O-Manager a number of clock cycles that require fast execution or a breakpoint condition that depends on a current state of the DUT, or both.

12. The simulation system of claim 11, wherein the I/O-Manager has a breakpoint logic that checks the breakpoint condition in the second operating mode.

13. The simulation system of claim 8, wherein in the second operating mode (mode 2) the clock (DUTClk) emitted to the DUT by the I/O-Manager has a higher frequency than the clock used in the first operation mode (mode 1).

14. A method for simulating at least one device-under-test (DUT) with a simulator operating at a predetermined clock frequency, said method comprising the steps of:
coupling a hardware block to the simulator, said hardware block having an I/O-Manager and the at least one DUT,
in a first operating mode, the I/O-Manager receiving a request from the simulator at every clock cycle and forwarding the request to the at least one DUT, and
in a second operating mode, the I/O-Manager transmitting clock cycles to the DUT without forwarding requests to the at least one DUT,
wherein switching between the first and second operating modes is seamless during a simulation.

15. The method of claim 14, wherein in the second operation mode, the simulator indicates to the I/O-Manager a number of clock cycles that require fast execution or a breakpoint condition that depends on a current state of the DUT, or both.

16. The method of claim 15, further comprising the step of checking in the second operation mode the breakpoint condition with a breakpoint logic that is part of the I/O-Manager.

17. The method of claim 14, wherein the transmitted clock cycles in the second operating mode have a higher frequency than the clock cycles in the first operating mode.

18. A computer program embodied on a computer-readable medium which causes a computer, after the program is loaded into computer memory, to cause the computer to simulate at least one device-under-test (DUT), by:
sending requests to an I/O-Manager connected between the computer and the at least one DUT at a predetermined clock rate,
in a first operating mode, the I/O-Manager forwarding the received requests to the at least one DUT at the predetermined clock rate, and
in a second operating mode, the I/O-Manager transmitting clock cycles at the predetermined clock rate to the at least one DUT, without also forwarding the received requests to the at least one DUT,
wherein switching between the first and second operating modes is seamless during a simulation.
